(19) United States
(12) Patent Application Publication
(10) Pub. No.: US 2005/0242156 A1
(43) Pub. Date: Nov. 3, 2005

(54) DLC (diamond-like carbon) hard coating on copper based material for bearings

(76) Inventors: Thomas Jabs, Ulm (DE); Michael Scharf, Dietenheim (DE); Martin Grischke, Schaan (LI); Orlaw Massler, Eschen (LI)

Correspondence Address: NOTARO AND MICHALOS, 100 DUTCH HILL ROAD, SUITE 110, ORANGEBURG, NY, 10962-2100, US

(21) Appl. No.: 11/115,457

(22) Filed: Apr. 27, 2005

(30) Foreign Application Priority Data
Apr. 29, 2004 (CH) 00751/04
May 25, 2004 (CH) 00897/04

(51) Int. Cl. B23K 1/00

(52) U.S. Cl. 228/101

(57) ABSTRACT

A bearing material of copper or a copper-containing alloy for use in friction bearings with a cover layer deposited at least on portions of the sliding face, is made up of at least a support layer and a sliding layer, the sliding layer being a hard coating and comprising diamond-like carbon.

### FIELD OF TECHNOLOGY

The invention relates to a bearing material of a copper-containing alloy for utilization in friction bearings.

### BACKGROUND OF THE INVENTION

Copper-containing bearing materials are known in prior art as well as the high suitability of copper materials for application of galvanic layers for surface finishing. In contrast, PVD, CVD or PVD/CVD layers have until now hardly been applied on relatively soft copper bearing materials, since, for example, under frictional stress with high loading the layer is pressed into the base material or breaks through, and many layer systems employed for coating tools have too high a coefficient of friction, too high a roughness or similar deficiencies.

European patent application EP 0288677 further discloses coating by means of a PVD method parts exposed to rolling stress of different types of steel with copper-containing friction bearing materials. The laid-open application DE 3742317 A1 also describes a method for the production of corrosion-, wear- and pressing-resistant layers with the aid of PVD technqiues on steel and special steel.

German patent application DE 4006550 describes a texturized cylinder for the reforming and processing of steel, which for the protection of the texture is protected against wear with galvanic hard chromium and a hard material layer deposited thereon by means of PVD or CVD methods. However, in this method the texture peaks are provided with a relatively thick layer, while the valleys are only coated with thinner layers or not at all.

German patent application DE 3011694 discloses a method for coating wear faces of contact surfaces. Therein, inter alia, the application of a galvanic adhesion layer onto different metallic materials is described and a subsequent PVD coating in a high-frequency plasma, in which a hard material layer based on carbide is deposited. Thereby good electric conductivity as well as increased wear protection is attained, however, a relatively high coefficient of friction results from the carbide coating.

German patent application DE 10018143 describes DLC layer systems with an adhesion, a transition and a covering layer, in which the covering layer comprises exclusively carbon and hydrogen.

German patent application DE 4421144 discloses coated tools in which for increasing the tool life is first applied a hard material layer of metal carbide and subsequently a free-carbon-containing friction-reducing layer on tungsten carbide base.

### SUMMARY OF THE INVENTION

It is an object of the present invention to provide a bearing material of copper or a copper-containing alloy for use in friction bearings with a cover layer deposited at least on portions of the sliding face, which is at least comprised of a support layer and a sliding layer, characterized in that the sliding layer is a hard coating and comprises diamond-like carbon.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### DESCRIPTION OF THE PREFERRED EMBODIMENTS OF THE INVENTION

The invention addresses the problem of providing a copper-containing bearing material, in which the disadvantages of prior art are avoided and a better service life behavior is achieved compared to conventionally coated materials.

This problem is resolved through the characteristics according to the invention in the characterizing clauses of the claims.

Through the application of DLC (diamond like carbon), modified according to the invention, frictional or hard coatings, which are deposited on copper or copper alloys, it becomes possible to increase the hardness of the surface, and therewith the wear and abrasion resistance of the materials, without their excellent tribological material properties being significantly changed. With a method as described in detail below a hard coating with defined tribological properties is deposited, which leads to an extension of the service life of the bearing materials. Relative to the substrate material, the coatings are hard and thereby protect it against abrasive wear. These hard coatings have, in addition, for example when utilized with steel as the counter-rotary partner, a low friction value and therewith prevent excessive temperature increases of the surface under frictional or rolling stress.

These properties make such bearing materials especially suitable for utilization as installation-ready friction bearings in general, as well as as friction bearings for engine building in particular. The low friction values prevent too high a heat introduction into the bearing and ensure even under minimal lubrication the safe running of the application and therewith a significant increase of the service life.

When utilized as friction bearings an especially distinctive improvement of the loading capacity could so far be observed in the case of the following copper-containing alloys coated according to the invention: bronze, brass or nickel brass. When using copper or other alloys or under different loading, for example such as occur in roller bearings, decided improvements could to some extent also be attained.

It can furthermore also be advantageous to utilize galvanically precoated bearing materials. Examples of these are Cr, Ni or CrNi coatings, which are applied before the support layer.

Due to their low deposition temperatures, plasma CVD, PVD or PVD/CVD hybrid methods are especially suited for the deposition of DLC layers for the coating of copper materials.

In the deposition of conventional DLC layers, described for example in DE 10018143, on the bearing material, however, largely independently of the layer thickness, abrasive wear in the form of furrow formation could be observed on the counter-rotary body and on the bearing material partly spotty spalling of the layer. Furthermore, to some extent blue discolorations occurred due to high temperature loading on the running faces of the counter-rotary body. This had initially been traced back to too great a hardness of the DLC layer.

However, by applying an additional support layer, which comprises at least one metal Me from the elements of subgroups IV, V, and VI of the periodic system of elements (i.e. Ti, Zr, Hf; V, Nb, Ta; Cr, Mo, W) or aluminum or Si, this disadvantageous effect could unexpectedly be avoided. Especially advantageous have been found to be support layers, which, in addition to the metallic phase, also comprise a nonmetal, such as C, N, B or O or the hard material compounds of the metals with these nonmetals. Only as examples are here listed the support layer systems TiN or Ti/TiN (i.e. a metallic titanium layer with a titanium nitride hard coating adjoining thereon), CrN or Cr/CrN, CrₓC_{y} or Cr/CrₓC_{y}, Crₓ(CN)_{y} or Cr/Crₓ(CN)Y, TiAl or TiAlN and TiAl/TiAlN.

Depending on the application case, attention must be paid to ensure that the support layer has a minimum layer thickness. This depends primarily on the surface pressing occurring depending on the application case. For example, at low surface pressing a satisfactory support effect of the DLC layer could already be attained with layer thicknesses of 0.5 μm, while with a support layer of 0.3 μm the support effect was no longer sufficiently assured. However, in general a layer thickness of at least 1 to approximately 3 μm is recommended. For applications, in which especially high surface pressing occurs, greater layer thicknesses can also be advantageous.

Between the support layer and the sliding layer additionally a metallic intermediate layer with or without graded transition can also be applied or directly a transition layer, for example in the form of a gradient layer with a carbon content increasing in the direction toward the sliding layer.

The DLC sliding layer itself is therefore advantageously implemented as follows. Directly on the support layer a metallic intermediate layer is deposited, which comprises at least one metal Me from the elements of subgroup IV, V, VI, or Al or Si. An intermediate layer of the elements Cr or Ti is preferably employed, which have been found to be especially suitable for this purpose. Nitridic, carbidic, boridic or oxidic intermediate layers or intermediate layers of a mixture of one or several metals with one or several of the listed nonmetals can also be utilized, which, optionally, can themselves be structured on a metallic base layer with or without graded transition.

Adjoining thereon or, alternatively, directly without an intermediate layer, is preferably a transition layer in particular in the form of a gradient layer, in the distribution of which the metal content decreases and the C content increases perpendicularly toward the workpiece surface. Incrementing the carbon can also take place by increasing optionally different carbidic phases, by increasing the free carbon or through a mixture of such phases with the metallic phase of the intermediate layer. The thickness of the gradient layer, as is known to a person of skill in the art, can therein be set by the adjustment of suitable process ramps. The increase of the C content or the decrease of the metallic phase can be continuous or stepwise, furthermore, at least in one portion of the gradient layer a sequence of individual high-metal and high-C layers can also be provided for the additional reduction of layer stresses. Through the described implementations of the gradient layer the material properties (for example E-modulus, structure, etc.) of the support and the DLC layer are substantially continuously adapted to one another and therewith the risk of crack formation along an otherwise occurring metal or Si/DLC boundary face is counteracted.

If especially hard surfaces are to be attained, the termination of the layer stack is formed as a layer essentially comprised exclusively of carbon and hydrogen, having a layer thickness which, in comparison to the intermediate layer, is greater. Such coatings are generally suitable for bearing sites, which cannot be worked in a subsequent operation, with high specific loading and restricted lubrication conditions, such as for example in the construction machine industry or in engine building.

The hardness of the entire DLC layer is therein set to a value greater than 15 GPa, preferably greater/equal to 20 GPa, and even with layer thicknesses >1 μm, preferably >2 μm on a steel test body with a hardness of approximately 60 HRC, an adhesion is attained greater or equal to HF 3, but preferably equal to HF 1 according to VDI 3824 Sheet 4. The surface resistance of the DLC layer is between δ=-10⁻⁶ Ω and δ =5 MΩ, preferably between 1 Ω]and 500 kΩ, at an electrode spacing of 20 mm. The present DLC layer is simultaneously distinguished by the low coefficients of friction typical for DLC, preferably μ≦0.3 in pin-on-disc testing.

Layer roughness: Rₐ=0.01-0.04; R_{z} DIN<0.8 preferably <0.5.

The growth rate of the DLC layer in the coating process is approximately 1-3 μm/h and, apart from the process parameters, depends also on the charging of the coating unit and the mounting of the parts. A particular effect is herein whether the parts to be coated are fastened on magnet mountings, or are clamped or plugged rotating simply, doubly ortriply. The overall mass and plasma penetrability of the mountings is also of significance. For example with light-weight constructed mountings, for example when utilizing spoke discs instead of discs of solid material, higher growth rates and an overall better layer quality are achieved, The layer stress in this case is 1-4 GPa and is consequently in the conventional range of hard DLC layers.

If, in contrast, especially good sliding and running-in properties are to be attained, it is advantageous to provide also in the terminal layer stack a residual metal content of one to maximally 20%, since such layers while having a slightly lower hardness (9 to 15 GPa) have a markedly lower coefficient of friction and, furthermore, make possible an even better dissipation of the frictional heat generated in the bearing.

Due to the mechanical running-in of the layer, the coating is especially suitable for friction bearings, since, for example, damage of the bearing through possibly occurring deficient lubrication is also prevented. Even one initial lubrication is possibly sufficient.

Based on the excellent conductivity of such metal-containing DLC layers, these can also be advantageously applied, if, in addition to the bearing function, also the transmission of electric signals is to be made possible.

A further important factor for the performance capability of bearing materials according to the invention is the correct setting of the percentage contact area in order to ensure, on the one hand, a maximally equidistributed large-area support effect and, on the other hand, a uniform distribution of the lubrication film by providing a sufficiently large number of so-called oil pockets on the surface. Through a large percentage-contact area A of the bearing face it is avoided that through the occurring bearing force F too high a spot loading, also referred to as pressing p, and a wear entailed therein (p=F/A) occur. The roughness (Rz) of the surface is therefore advantageously set to less than or maximally equal to 4 μm.

Table 1 shows here by example profiles, generated by different working of the surface, all of which have the same Rz value, namely 1 μm. Profiles 5 and 7 have an especially high percentage of contact areas. The percentage contact area tₚ is therefore at a cut level of 0.75 μm advantageously set to between 60 to 98%, preferably between 75 and 95%, at a cut level of 0.50 μm between 50 and 90%, preferably between 70 and 90%.

The setting of such surface structures takes place in every case before the application of the PVD or CVD coating, since these methods retain the structure of the surface. If a possibly provided galvanic precoating also fulfills this requirement, the fine working of the surface can advantageously take place even before this step.

TABLE 1

| | | | Cut Level | | |
|---|---|---|---|---|---|
| Profile | R_{z} | Rₐ | 0.25 | 0.50 | 0.75 |
| Types | μm | μm | tp % | tp % | tp % |
| 1 R_{z}/Rₘₐₓ | 1 | 0.500 | 50.0 | 50.0 | 60.0 |
| 2 R_{z}/Rₘₐₓ | 1 | 0.250 | 25.0 | 50.0 | 75.0 |
| 3 R_{z}/Rₘₐₓ | 1 | 0.250 | 25.0 | 50.0 | 75.0 |
| 4 R_{z}/Rₘₐₓ | 1 | 0.280 | 12.5 | 25.0 | 37.5 |
| 5 R_{z}/Rₘₐₓ | 1 | 0.280 | 62.5 | 75.0 | 87.5 |
| 6 R_{z}/Rₘₐₓ | 1 | 0.188 | 3.5 | 14.0 | 35.0 |
| 7 R_{z}/Rₘₐₓ | 1 | 0.188 | 65.0 | 88.0 | 96.5 |
| 8 R_{z}/Rₘₐₓ | 1 | 0.390 | 43.0 | 50.0 | 57.0 |

### EXAMPLES AND TESTS

In the following the invention will be described in conjunction with several embodiment examples. All DLC layers, or support layers, were deposited at temperatures of less than 250° C. on copper materials, in a Balzers BAI 830 production unit modified as in DE 100 18 143 under FIG. 1 and associated description [0076] to [0085]. For this purpose, in all coatings pretreatment with a heating and etching process was carried out, known from process example 1 of said document, utilizing a low-voltage arc. The correspondingly denoted locations of the above laid-open application are declared to be an integral component of the present application.

### Comparison Example 1

By means of a chromium adhesion layer, but without additional support layer, a DLC sliding layer, metal-free in the terminal, i.e. outer, layer region, was applied on a CuSn8 bronze. After the above described pretreatment the following process steps were selected:

First, the application of the Cr adhesion layer was started by activating two CR magnetron sputter targets positioned at opposite sites of the interior diameter of the vacuum coating unit. The Ar gas flow is set to 115 sccm. The Cr sputter targets are driven at a power of 8 kW and the substrates are now rotated past the targets for a period of time of 6 min. The ensuing pressure range is subsequently between 10⁻³ mbar and 10⁻⁴ mbar. The sputter process is supported during the first three minutes by connecting in the low-voltage arc and by continuously applying to the substrate a negative DC bias voltage of 75 V.

After the passage of this time and after the DC bias voltage has been switched off, by switching on a different bias voltage, also applied to the workpiece holder, an additional plasma is ignited with a bipolar pulse generator, acetylene gas with an initial flow rate of 50 sccm is introduced and the flow is increased by 10 sccm every minute.

The bipolar pulse plasma generator is set to a pulse voltage of −900 V at a frequency of 50 kHz. The generator is connected between the workpiece mountings and the housing wall of the receptacle. Both Helmholtz coils disposed on the receptacle are activated with a constant current throughflow of 2 A in the lower coil and 8 A in the upper coil. At an acetylene flow of 230 sccm the Cr targets are deactivated and the cover layer exclusively containing carbon and hydrogen is applied while maintaining the parameters given in Table 2.

TABLE 2
Coating parameters DLC cover layer

| | | |
|---|---|---|
| Argon flow | 30 | sccm |
| Acetylene flow | 280 | sccm |
| Coil voltage upper coil | 8 | A |
| Coil voltage lower coil | 2 | A |
| Excitation voltage | −900 | V |
| Excitation frequency | 50 | kHz |
| Coating time/layer thickness | appr. 2 | h/2 μm |

### Example 2

For the tests with a CrN support layer a DLC sliding layer as described in example 1 was applied onto the support layer. For the deposition of the support layer applied directly onto the workpiece, the process parameters specified in Table 3 were used.

TABLE 3
Coating parameters CrN support layer

| | | |
|---|---|---|
| Argon flow | 100 | sccm |
| Nitrogen flow | 100 | sccm |
| Arc current | 75 | A |
| Bias voltage | −100 | V |
| Coil voltage upper coil | 6 | A |
| Coil voltage lower coil | 0 | A |
| Target power | 2 × 8 | kW |

### Comparison Example 3

A DLC sliding layer containing metal in the terminal, i.e. outer, layer region was applied onto a CuSn8 bronze by means of a chromium adhesion layer but without additional support layer. After the above described pretreatment, first a chromium adhesion layer was applied as in Example 1.

With the Cr targets activated, subsequently six WC targets were activated with a power of 1 kW and both target types were allowed to run simultaneously for 2 min. The power of the WC targets was increased over 2 minutes from 1 kW to 3.5 kW at constant argon flow. Simultaneously, the negative substrate bias on the structural parts is increased in the form of a ramp. Starting from the voltage applied at the end of the Cr adhesion layer, the substrate bias was increased over 2 min up to −300 V. The −300 V are thus reached when the WC targets run at maximum power. The Cr targets are subsequently switched off. The WC targets are allowed to run for 6 min at constant Ar flow, the acetylene gas flow is subsequently increased over 11 min to 200 sccm.

During the last coating phase for the application of the metal-containing DLC cover layer the parameters described in Table 4 are kept constant.

TABLE 4
Coating parameters metal-containing DLC cover layer

| | | |
|---|---|---|
| Argon flow | 115 | sccm |
| Acetylene flow | 200 | sccm |
| Bias voltage | −300 | V |
| Coil voltage upper coil | 6 | A |
| Coil voltage lower coil | 0 | A |
| Target power | 6 × 3.5 | kW |

### Example 4

For the tests with a CrN support layer, a metal-containing DLC sliding layer as described in Example 3 was applied onto a CrN support layer as explained in Example 2.

Tribometer Tests

To assess the suitability of the particular layer for use as bearing material, different tests were performed with a Wazau ring-on-disc tribometer type TRM 1000 (area contact).

The test conditions were as follows:

| | |
|---|---|
| Contact geometry: | Ring-on-disc area contact, |
| | ring diameter 30/35 mm; |
| | area 255.3 mm²; circumference |
| | 102.1 mm |
| Movement: | rotating, 30 R/min |
| Sliding velocity: | 0.5 m/s |
| Load (running-in): | 300 N, 5 minutes |
| Load (run): | 1000 N |
| Specific load (pressing): | 4 MPa |
| Length of test (incl. running-in): | 10 hours |
| Sliding path after 10 h: | 18.378 m |
| Ring (bushing): | CuSn8 coated |
| Roughness: | Rz < 4 μm |
| Disc (counter-rotary body): | 100 Cr6, 60-62 HRc, lapped, |
| | Rz appr. 1 μm, Ra appr. 0.7 μm |
| Lubricant (oil bath): | Motor oil SAE 30 |
| Starting temperature: | ambient temperature, without cooling |
| Measured parameters: | moment of friction and wear |
| | (continuous, online) and |
| | evaluation of the bearing |
| | surfaces under optical |
| | microscope after the test |

For judging the bearing load the product of pressing p and sliding velocity v is significant. Values around 2 for p*v are conventional orders of magnitude. If one factor of the product is increased, the other must be correspondingly reduced to ensure controllable running. Depending on the base strength of the bearing material, pressings up to 200 MPa are realizable. Conventional orders of magnitude of bearings of high-load capacity, for example in construction machines, are 100 MPa.

The following Table 5 provides an overview over the tests, in each of which an uncoated disc (counter-rotary body) rotates on a standing uncoated or coated disc (bearing). On the coated bearings a DLC layer according to Example 1 and 2 (metal-free cover layer) had been applied.

Test 1, both discs uncoated: the wear rate is always very high and the spread of the values of the wear is extreme. If such material combinations were to be utilized for example in motor bearings under such high loads, a complete bearing failure would occur immediately or at least very rapidly.

Test 2 and 3, counterbody DLC coated, without support layer: the wear rate is lower by a factor of 2 to 7 than in the tests with uncoated discs. However, in a visual assessment with the unaided eye, or macroscopically, damages of the surface can always still be seen, such as partially a blue discoloration due to overheating, spotty spalling of the layer, spot occurrence of adhesion phenomena on the counterbody and the like.

Test 4 and 5, counterbody coated with support and DLC layer according to Example 2: wear rate similarly low as in tests 2 and 3. At the same time, in the visual assessment defect sites can no any longer be found on the coated bearing. On the counterbody only mild abrasions can be observed under the microscope even after 18.378 m (=sliding path after 10 h).

Table 6 provides an overview over the tests, in which a metal-containing DLC layer according to Example 3 and 4 had been applied on the coated discs.

As can be seen in tests 6 and 7, it is evident that with the direct application of the sliding layer no satisfactory stability of the layer on the base material can be attained. Under sliding stress premature failure of the surface with scale-like spalling of individual layer portions occurs, which can cause severe wear on both running partners.

Test 8 and 9, counterbody coated with support and DLC layer according to Example 4: in contrast to the high wear rate detected partially on both discs in tests 6 and 7, such bearing/counterbody combination shows only evidence of very low wear rate. The defect sites, detectable in the visual assessment on the coated bearing, can now only be detected in isolation and in spots under the microscope. Even after 18.378 m (=sliding path after 10 h) only mild abrasion phenomena can be detected on the counterbody under the microscope.

TABLE 5

| Test | Bearing | Wear Rate | Temp. | Friction Value | Friction Value | | |
|---|---|---|---|---|---|---|---|
| No. | Material | [μm/km] | [° C.] | min. | max. | R_{z} | Assessment |
| 1 | CuSn8 | 0.49 | 88 | 0.042 | 0.066 | 4 | poor |
| | uncoated | 0.93 | 38 | 0.064 | 0.850 | | |
| | | 1.36 | 68 | 0.043 | 0.055 | | |
| 2 | CuSn8 with | <0.19 | 106 | 0.070 | 0.089 | 4 | good |
| | DLC accord. | <0.19 | 113 | 0.063 | 0.080 | | |
| | to Example 1 | | | | | | |
| 3 | CuSn8 with | <0.16 | 138 | 0.076 | 0.084 | 2 | good |
| | DLC accord. | | | | | | |
| | to Example 1 | | | | | | |
| 4 | CuSn8 with | <0.16 | 134 | 0.072 | 0.079 | 2 | very good |
| | CrN & DLC | <0.17 | 140 | 0.075 | 0.081 | | |
| | accord. to | | | | | | |
| | Claim Example 2 | | | | | | |
| 5 | CuSn8 with | <0.1 | 136 | 0.064 | 0.075 | 4 | very good |
| | CrN & DLC | <0.1 | 141 | 0.072 | 0.073 | | |
| | accord. to | <0.1 | 141 | 0.059 | 0.072 | | |
| | Claim Example 2 | | | | | | |

TABLE 6

| Test | Bearing | Wear Rate | Temp. | Friction Value | Friction Value | | |
|---|---|---|---|---|---|---|---|
| No. | Material | [μm/km] | [° C.] | min. | max. | R_{z} | Assessment |
| 6 | CuSn8 with | 0.057 | 50 | 0.025 | 0.031 | 4 | poor |
| | WCC accord. | 2.99 | | 0.045 | 0.220 | | |
| | to Example 3 | | | | | | |
| 7 | CuSn8 with | 0.26 | 132 | 0.070 | 0.068 | 2 | poor |
| | WCC accord. | 0.47 | 122 | 0.068 | 0.073 | | |
| | to Example 3 | | | | | | |
| 8 | CuSn8 with | <0.1 | 143 | 0.072 | 0.078 | 2 | good |
| | CrN & WCC | <0.1 | 135 | 0.067 | 0.072 | | |
| | accord. to | <0.1 | 141 | 0.065 | 0.070 | | |
| | Example 4 | | | | | | |
| 9 | CuSn8 with | <0.1 | 133 | 0.068 | 0.075 | 4 | good |
| | CrN & WCC | <0.1 | 148 | 0.061 | 0.090 | | |
| | accord. to | <0.1 | 142 | 0.066 | 0.070 | | |
| | Example 4 | | | | | | |

While specific embodiments of the invention have been shown and described in detail to illustrate the application of the principles of the invention, it will be understood that the invention may be embodied otherwise without departing from such principles.

1. Bearing material of copper or a copper-containing alloy for use in friction bearings with a cover layer deposited at least on portions of the sliding face, which is at least comprised of a support layer and a sliding layer, characterized in that the sliding layer is a hard coating and comprises diamond-like carbon.

2. Bearing material as claimed in claim 1, characterized in that at least the sliding layer comprises exclusively the elements carbon, or carbon and hydrogen, as well as unavoidable impurities from the coating process.

3. Bearing material as claimed in claim 1, characterized in that the sliding layer additionally comprises at least one metal Me from the elements of subgroups IV, V and VI of the periodic system of elements including at least one of Ti, Zr, Hf; V, Nb, Ta; Cr, Mo and W, or Si.

4. Bearing material as claimed in claim 3, characterized in that the sliding layer comprises a WC layer and a WC layer deposited thereon with a free carbon-content increasing toward the surface of the layer.

5. Bearing material as claimed in claim 1, characterized in that the support layer comprises at least one metal Me from the elements of subgroups IV, V, and VI of the periodic system of elements including at least one of Ti, Zr, Hf; V, Nb, Ta; Cr, Mo and W, or aluminum, or Si.

6. Bearing material as claimed in claim 3, characterized in that the support layer additionally or exclusively comprises one or several hard material compounds, which includes at least one metal Me and at least one nonmetal, the metal is at least one of the elements of the subgroups IV, V, and VI of the periodic system of elements including at least one of Ti, Zr, Hf; V, Nb, Ta; Cr, Mo and W, or aluminum, or Si, and the nonmetal is at least one of the elements C, N, B or O.

7. Bearing material as claimed in claim 3, characterized in that between the support layer and the sliding layer a transition layer is included.

8. Bearing material as claimed in claim 7, characterized in that the transition layer is comprised of at least one metal Me from the elements of subgroups IV, V, and VI of the periodic system of elements including at least one of Ti, Zr, Hf; V, Nb, Ta, Cr, Mo and W, or aluminum, or Si.

9. Bearing material as claimed in claim 7, characterized in that the transition layer is a gradient layer, the C content of the transition layer increasing toward the sliding layer.

10. Bearing material as claimed in claim 1, characterized in that the copper-containing alloy is bronze, brass or nickel brass.

11. Bearing material as claimed in claim 1, characterized in that the copper-containing alloy is galvanically precoated.

12. Bearing material as claimed in claim 1, characterized in that the copper-containing alloy is galvanically precoated with a Cr, an Ni or a CrNi alloy.

13. Bearing material as claimed in claim 1, characterized in that at a cut level of 0.75 the percentage of contact area tₚ is between 60 to 98%.

14. Bearing material as claimed in claim 1, characterized in that at a cut level of 0.75 the percentage of contact area tₚ is between 75 to 95%.

15. Bearing material as claimed in claim 1, characterized in that at a cut level of 0.50 the percentage of contact area tₚ is between 50 to 90%.

16. Bearing material as claimed in claim 1, characterized in that at a cut level of 0.50 the percentage of contact area tₚ is between 70 to 90%.
